(19) United States
(12) Patent Application Publication
(10) Pub. No.: US 2004/0246334 A1
(43) Pub. Date: Dec. 9, 2004

(54) Image portrayal system

(76) Inventor: Dimitri Philippou, Cape Town (ZA)

Correspondence Address: STITES & HARBISON PLLC, 1199 NORTH FAIRFAX STREET, SUITE 900, ALEXANDRIA, VA, 22314, US

(21) Appl. No.: 10/488,198

(22) PCT Filed: Aug. 8, 2002
(86) PCT No.: PCT/IB02/03515

(30) Foreign Application Priority Data
Aug. 30, 2001 (ZA) 2001/7178

(51) Int. Cl. H04N 13/00

(52) U.S. Cl. 348/42

(57) ABSTRACT

The invention discloses an image portrayal system, which includes transmission means for transmitting signals, input means for providing signals to be transmitted to the transmission means, and output means for portraying the signals received by it from the transmission means as at least a three-dimensional image. The image may be a hologram or a four-dimensional. The transmission means may include the internet, a local-area network (LAN), a wide-area network (WAN), any other networks, mobile telephone communication, land-line telephone communication, satellite communication, and any other forms of transmission and/or communication.

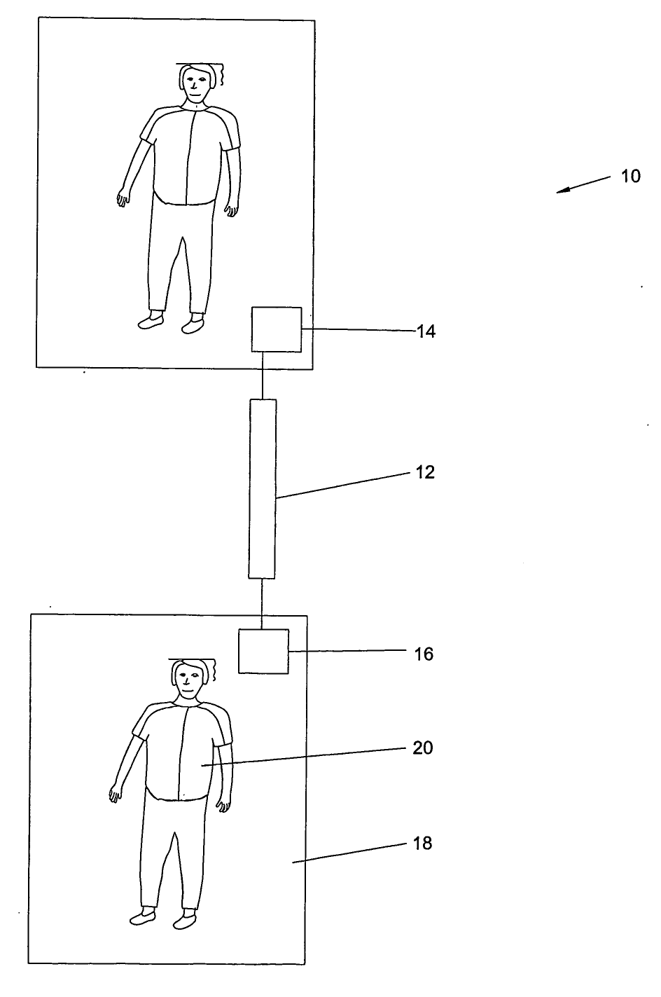

### FIELD OF INVENTION

The present invention relates to image portrayal systems. More particularly, the present invention relates to image portrayal systems for portraying three-dimensional images.

### BACKGROUND TO INVENTION

The developments in the electronic and information technology fields have revolutionised the distribution of information and means of communication. The Internet, e-mails, mobile phones, satellites, pagers, networks and similar communication devices, instruments and systems, have enabled mankind to transmit information at a hitherto unseen rate. However, the aforementioned communication equipment only permits the sending of sound and 2-dimensional images.

It is an object of the invention to suggest an image portrayal system for over-coming the aforementioned problem.

### SUMMARY OF INVENTION

According to the invention, an image portrayal system includes

(a) transmission means for transmitting signals;

(b) input means for providing signals to be transmitted to the transmission means; and

(c) output means adapted to receive signals from the transmission means received from the input means and to portray the signals received from the transmission means as a multidimensional output image being at least a three-dimensional output image.

Also, according to the invention, a method for portraying images, includes the steps

(a) of providing signals to be transmitted to transmission means;

(b) of transmitting the signals transmitted to the transmission means to output means; and

(c) of portraying the signals received by the output means from the transmission means as a multidimensional output image being at least a three-dimensional output image.

The output image may be a four-dimensional image.

The output image may be portrayed in colour.

The output image may consist of matter.

The output image may be portrayed by using nanotechnology.

At least some of the signals may transmit data.

A time delay from transmission of signals by the transmission means and/or receipt by the output means until the output image is portrayed may be included.

A time delay from provision of signals to the transmission means and/or receipt by the output means until the output image is portrayed may be included.

The transmission means may include the Internet, a local-area network (LAN), a wide-area network (WAN), any other networks, mobile telephone communication, land-line telephone communication, radio communication, satellite communication, radio-waves, micro-waves, and any other forms of transmission and/or communication.

The transmission of the signals may be real-time.

The transmission of the signals may be controlled from the input means and/or from the output means.

The output image may be a hologram.

The output image may be a human figure.

The signals may be provided to the input means in electronic form.

The signals may be directly obtained by the input means from an input image and/or object and/or human.

Sound associated with the output image may be included.

The output image may be adapted to speak.

The system may be utilised for business means, such as advertising, promotions, marketing and selling.

The method may be utilised for business means, such as advertising, promotions, marketing and selling.

The system may be utilised for educational or entertainment means, such as teaching in classes and provision of shows.

The method may be utilised for educational or entertainment means, such as teaching in classes and provision of shows.

The system may be utilised for replacing specific functions performed by humans.

The method may be utilised for replacing specific functions performed by humans.

The transmission means, the input means and/or the output means may be remotely operated.

The remote operation may be via a telephone landline, the internet, or a mobile telephone or other communication.

### BRIEF DESCRIPTION OF DRAWING

The invention will now be described by way of example with reference to the accompanying schematic drawing.

In the drawing there is shown a schematic view of an embodiment of an image portrayal system in accordance with the invention.

### DETAILED DESCRIPTION OF DRAWING

Referring to the drawing, an embodiment of an image portrayal system, in accordance with the invention and generally indicated by reference numeral 10, is shown.

The image portrayal system 10 includes a transmission means 12, which is the internet in the present embodiment example, input means 14, in this example internet data/signal provider, and output means 16 located at a remote position from the input means 14. The output means 16 is located in this example in a lecture room 18.

In operation, a user located in the lecture room 18 remotely activates the input means 14 which then transmits predetermined signals/data across the transmission means 12 to the output means 16. A three-dimensional image 20 associated with the transmitted signals/data is then displayed in the lecture room 18.

The three-dimensional image may be a hologram, i.e. an image produced by holography which is an imaging technique which records and reconstructs the wave-front emanating from an illuminated object.

By means of the image portrayal system in accordance with the invention, certain functions performed by humans may be replaced with a three-dimensional human image.

List of Reference Numerals

10 Image portrayal system

12 Transmission means

14 Input means

16 Output means

18 Lecture room

20 Three-dimensional image

1. An image portrayal system, which includes
(a) transmission means for transmitting signals;
(b) input means for providing signals to be transmitted to the transmission means; and
(c) output means adapted to receive signals from the transmission means received from the input means and to portray the signals received from the transmission means as a multidimensional output image being at least a three-dimensional output image.

2. A system as claimed in claim 1, in which the output image is a four-dimensional image.

3. A system as claimed claim 1 or claim 2, in which the output image is portrayed in colour.

4. A system as claimed in any one of the preceding claims, in which the output image consists of matter.

5. A system as claimed in any one of the preceding claims, in which the output image is portrayed by using nanotechnology.

6. A system as claimed in any one of the preceding claims, in which at least some of the signals transmit data.

7. A system as claimed in any one of the preceding claims, which includes a time delay from transmission of signals by the transmission means and/or receipt by the output means until the output image is portrayed.

8. A system as claimed in any one of the preceding claims, which includes a time delay from provision of signals to the transmission means and/or receipt by the output means until the output image is portrayed.

9. A system as claimed in any one of the preceding claims, in which the transmission means includes the Internet, a local-area network (LAN), a wide-area network (WAN), any other networks, mobile telephone communication, land-line telephone communication, radio communication, satellite communication, radio-waves, micro-waves, and any other forms of transmission and/or communication.

10. A system as claimed in any one of the preceding claims, in which the transmission of the signals is real-time.

11. A system as claimed in any one of the preceding claims, in which the transmission of the signals are controlled from the input means and/or from the output means.

12. A system as claimed in any one of the preceding claims, in which the output image is a hologram.

13. A system as claimed in any one of the preceding claims, in which the output image is a human figure.

14. A system as claimed in any one of the preceding claims, in which the signals are provided to the input means in electronic form.

15. A system as claimed in any one of the preceding claims, in which the signals are directly obtained by the input means from an input image and/or object and/or human.

16. A system as claimed in any one of the preceding claims, which includes sound associated with the output image.

17. A system as claimed in any one of the preceding claims, in which the output image is adapted to speak.

18. A system as claimed in any one of the preceding claims, which is utilised for business means, such as advertising, promotions, marketing and selling.

19. A system as claimed in any one of the preceding claims, which is utilised for educational or entertainment means, such as teaching in classes and provision of shows.

20. A system as claimed in any one of the preceding claims, which is utilised for replacing specific functions performed by humans.

21. A system as claimed in any one of the preceding claims, in which the transmission means, the input means and/or the output means are remotely operated.

22. A system as claimed in claim 21, in which the remote operation is via a telephone landline, the internet, or a mobile telephone or other communication.

23. A method for portraying images, which includes the steps
(a) of providing signals to be transmitted to transmission means;
(b) of transmitting the signals transmitted to the transmission means to output means; and
(c) of portraying the signals received by the output means from the transmission means as a multidimensional output image being at least a three-dimensional output image.

24. A method as claimed in claim 23, in which the output image is a four-dimensional image.

25. A method as claimed claim 23 or claim 24, in which the output image is portrayed in colour.

26. A system as claimed in any one of claims 23 to 25, in which the output image consists of matter.

27. A system as claimed in any one of claims 23 to 26, in which the output image is portrayed by using nanotechnology.

28. A system as claimed in any one of claims 23 to 27, in which at least some of the signals transmit data.

29. A method as claimed in any one of claims 23 to 28, which includes a time delay from transmission of signals by the transmission means and/or receipt by the output means until the output image is portrayed.

30. A method as claimed in any one of claims 23 to 29, which includes a time delay from provision of signals to the transmission means and/or receipt by the output means until the output image is portrayed.

31. A method as claimed in any one of claims 23 to 30, in which the transmission means includes the Internet, a local-area network (LAN), a wide-area network (WAN), any other networks, mobile telephone communication, land-line telephone communication, radio communication, satellite communication, radio-waves, micro-waves, and any other forms of transmission and/or communication.

32. A method as claimed in any one of claims 23 to 31, in which the transmission of the signals is real-time.

33. A method as claimed in any one of claims 23 to 32, in which the transmission of the signals are controlled from the input means and/or from the output means.

34. A method as claimed in any one of claims 23 to 33, in which the output image is a hologram.

35. A method as claimed in any one of claims 23 to 34, in which the output image is a human figure.

36. A method as claimed in any one of claims 23 to 35, in which the signals are provided to the input means in electronic form.

37. A method as claimed in any one of claims 23 to 36, in which the signals are directly obtained by the input means from an input image and/or object and/or human.

38. A method as claimed in any one of claims 23 to 37, which includes sound associated with the output image.

39. A method as claimed in any one of claims 23 to 38, in which the output image is adapted to speak.

40. A method as claimed in any one of claims 23 to 39, which is utilised for business means, such as advertising, promotions, marketing and selling.

41. A method as claimed in any one of claims 23 to 40, which is utilised for educational or entertainment means, such as teaching in classes and provision of shows.

42. A method as claimed in any one of claims 23 to 41, which is utilised for replacing specific functions performed by humans.

43. A method as claimed in any one of claims 23 to 42, in which the transmission means, the input means and/or the output means are remotely operated.

44. A method as claimed in claim 43, in which the remote operation is via a telephone landline, the internet, or a mobile telephone or other means of communication.
